(19) United States
(12) Patent Application Publication
(10) Pub. No.: US 2006/0233411 A1
(43) Pub. Date: Oct. 19, 2006

(54) Hearing enhancement and protection device

(76) Inventor: Shawn Utigard, Seattle, WA (US)

Correspondence Address: BLACK LOWE & GRAHAM, PLLC, 701 FIFTH AVENUE, SUITE 4800, SEATTLE, WA, 98104, US

(21) Appl. No.: 11/354,290

(22) Filed: Feb. 14, 2006

Related U.S. Application Data
(60) Provisional application No. 60/652,972, filed on Feb. 14, 2005.
(60) Provisional application No. 60/663,616, filed on Mar. 18, 2005.

(51) Int. Cl. H04R 25/00

(52) U.S. Cl. 381/328; 381/312

(57) ABSTRACT

A device for providing hearing enhancement and hearing protection. The device includes a means to amplify sounds that do not exceed a specified sound threshold limit. The sound output is restricted to a non-harmful range so that loud, burst full sounds are limited to a safe range and weaker sounds are enhanced for hearing.

### PRIORITY CLAIM

This application claims priority to U.S. Provisional Patent Application Ser. No. 60/652,972 filed Feb. 14, 2005 and U.S. Provisional Patent Application Ser. No. 60/663,616 filed Mar. 18, 2005. Each of the above applications is hereby incorporated by reference in its entirety as if fully set forth herein.

### FIELD OF THE INVENTION

This invention relates generally to a hearing enhancement and hearing protection device.

### BACKGROUND OF THE INVENTION

Game hunters universally desire to locate and capture prey. Hunting takes place in remote environments that are extremely quiet and often dense with natural obstructions. Because of the quiet and obstructed nature of this environment, a hunter relies extensively on his or her hearing faculty to locate prey. However, the unaided human hearing sensory system has limits that render it unable to detect many useful sounds that are present in the hunting environment.

The interesting and unique corollary to the need for extremely sensitive hearing faculty is the absolute requirement for hearing protection. Upon locating a prey, the hunter must quietly position herself and discharge a gun. The resulting muzzle-blast results in an overwhelmingly intense and close-range sound that can damage the hunter's hearing faculty.

In response to the desire to hear more sounds, the hunter may choose to wear a hearing enhancement device. Although a hearing enhancement device will assist in the location of prey, the device will also have the undesirable and harmful result of amplifying muzzle blasts when the hunter discharges his gun.

As an alternative, the hunter may choose to utilize a hearing protection device, commonly in the form of earplugs, to dampen intense sounds generated by muzzle blasts. However, the hearing protection device indiscriminately reduces all sounds perceived by the hunter. Therefore, the hunter will be unable to perceive many desirable sounds necessary to successfully locate prey.

In response to the problems associated with utilizing either a hearing enhancement device or a hearing protection device, the hunter may choose to refrain from utilizing either device or use both devices. When the hunter refrains from using either device, she is limited to her natural hearing abilities and still susceptible to hearing damage from the sounds of muzzle blasts. As an alternative, the hunter may choose to use a hearing enhancement device while locating prey and then switch to a hearing protection device while discharging the gun. However, the time required and the associated noise would make this option undesirable in the hunting environment.

### SUMMARY OF THE INVENTION

A hearing device that amplifies sounds at a defined increment up to or beneath a specified threshold level. The device features a fixed volume that is not user-adjustable. In other embodiments, the device may also include a user-adjustable volume control with an on/off switch. Both the fixed volume and user-adjustable volume devices can be fitted for placement in ear canals. The device thus has the ability to amplify weak sounds and limiting loud sounds, especially sounds of a high intensity, short burst nature.

The device includes a case or shell with a microphone disposed to receive exterior sounds from the surrounding environment, a speaker disposed to emit amplified but threshold-limited sounds towards the eardrum, and a circuit board interposed and connected with the microphone and speaker. The circuit board converts the exterior sounds to signals for amplification by fixed decibel increments that do not exceed the specified threshold decibel level. The circuit board changes or converts the amplified and threshold-limited signals to interior sounds that emerge from the speaker and progress towards the eardrum. The interior sounds reaching the eardrum are amplified to enhance hearing but limited to a decibel maximum to confer hearing protection. The device is powered by a replaceable hearing aid battery which is placed within an opening battery compartment that also functions as an on/off switch.

The specially-engineered case connects with an interchangeable silicone or vinyl ear tip to form a non-obtrusive device that fits comfortably into the canal and fills in the gaps between the case and surfaces of the ear canal. The device is designed to fit the ear bilaterally and therefore has no left or right designation. The interchangeable ear tips come in a variety of sizes to fit most variations in ear size, and when properly positioned, helps absorb or dampen the loud sound bursts that otherwise would be communicated unattenuated through the open spaces between the case and ear canal surfaces.

### BRIEF DESCRIPTION OF THE DRAWINGS

Preferred and alternative embodiments of the present invention are described in detail below with reference to the following drawings.

FIG. 1 is a cross-sectional view of the first embodiment, according to the principles of the invention.

### DETAILED DESCRIPTION OF THE EMBODIMENTS

In one embodiment, the hearing device is small enough to be worn inside the user's ear. The hearing device is interchangeable between ears and comes in multiple sizes; therefore, the device does not necessarily need to be custom fitted. The device has a hard shell or case that houses a battery compartment, microphone, amplification and threshold-setting circuit, and receiver/speaker. The battery door operates as the on/off switch. The shell is circumscribed by a silicone material that creates a seal between the shell and the user's ear. The seal functions as a sound barrier to prevent sound from entering through space between the shell and the user's ear. The seal is removable and replaceable by the user. Within the shell, the microphone captures sounds and delivers sound signals to the amplification circuit. The amplification circuit amplifies all incoming signals to the extent the output signal is non-harmful to the user, most commonly the output signal is limited to less than 100 dB SPL. The amplification is a non-adjustable fixed gain, most commonly about 17 dB. The receiver or speaker delivers the amplified signal to the user's tympanic membrane. Because the seal prevents sound from entering between the shell and the user's external auditory canal, the only sound that the wearer perceives is that sound captured by the hearing device, amplified, and presented by the speaker to the wearer's auditory medium.

In another embodiment, the microphone, battery, amplification circuit, or receiver may be external to the shell and carried outside the user's ear. The signal may be transmitted by wire or alternative means to the speaker in the user's ear.

In another embodiment, the hearing device may not be interchangeable between the ears. Further, the shell may be custom fitted or made of soft material.

In another embodiment, the on/off switch may be a switch or button or alternative means to activate the device and may be located on any part of the device.

In another embodiment, the ear tip may be made of foam that provides a suitable sound barrier. Also, the ear tip may be permanently fixed or attached to the shell. Alternatively, the shell may itself function as a sound seal if designed appropriately.

In another embodiment, the amplification may be user-adjustable. Alternatively, the gain may be variable over the frequency range.

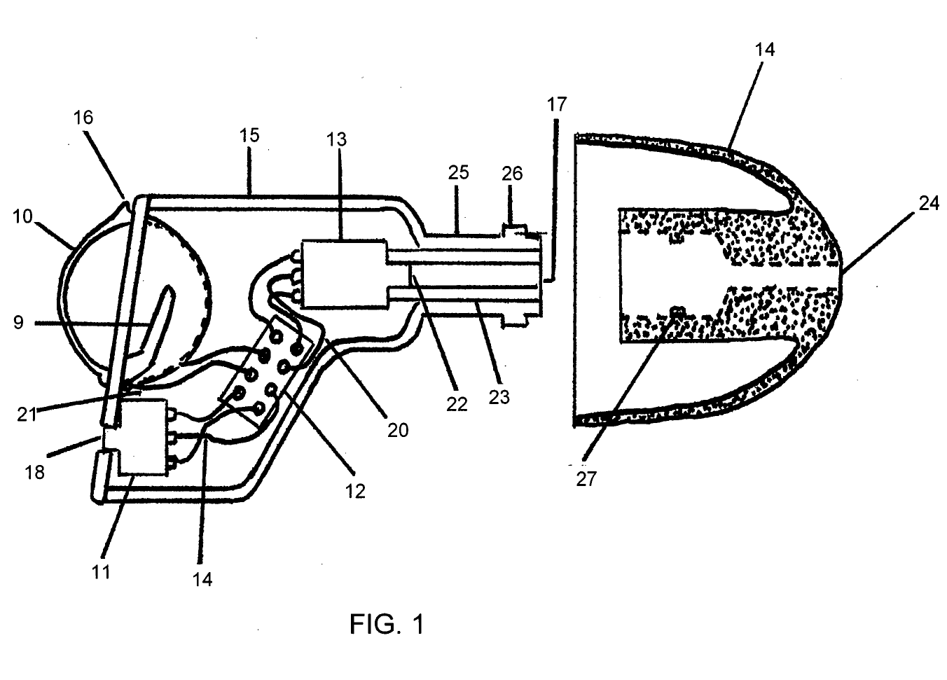

FIG. 1 shows a cross-sectional view of a first embodiment of the invention. The device includes a shell 15 and interchangeable, removable, and replaceable star tip 14 to make contact with the surfaces of the ear canal. The star tip 14 may be constructed of a foam-like material or a silicone-based material such that a spring-like flexibility is imparted to the star tip 14 so that an effective seal is maintained between the ear canal surfaces the shell 15, further imparting a secure holding of the shell 15 within the canal. The shell 15 houses a battery compartment 10, a microphone 11, an amplification circuit 12, and a receiver 13. The battery compartment 10 also functions as an on/off switch 16. Electricity is transmitted from the battery compartment 10 by battery contact 9 to amplification circuit 12 by means of conductive material 21. The device is positioned in the user's ear with shell opening 17 and star tip opening 24 directed toward the tympanic membrane and shell opening 18 directed externally. Sound waves enter the device through opening 18 and microphone 11 converts the incoming sound waves to electrical signals. Conductive material 19 transmits the electrical signal to the amplification circuit 12. The amplification circuit 12 amplifies the incoming signal and transmits the resulting amplified signal to receiver 13 by means of conductive material 20. Receiver 13 converts the amplified signal to analog sound waves utilizing speaker 22. Speaker 22 directs sound waves to shell opening 17 and star tip opening 24 utilizing tube 23. Star tip 14 circumscribes the shell 15 beginning at shell opening 17 and extending along the shaft of shell 25. Star tip 14 has an aperture 24 to allow sound traveling in channel 23 to reach the user's tympanic membrane. Star tip 14 forms a sound seal and barrier to prevent sound from entering between shell 15 and the user's ear. Ear tip 14 locks to shell shaft 25 by interlock 26 on shell and 27 on star tip.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A hearing device comprising:
a case configured to fit in an ear canal;
a microphone disposed near the exterior end of the case and positioned to receive exterior sounds;
a speaker disposed near the interior end of the case and positioned to transmit interior sounds; and
an electronic circuit connected with the microphone and the speaker, the circuit having a threshold level and configured to produce amplified exterior signals from the exterior sounds by fixed increments that do not exceed the threshold level,
wherein the amplified exterior signals are converted to the interior sounds and emerge from the speaker at or beneath the threshold limit.
